(19) United States
(12) Patent Application Publication
(10) Pub. No.: US 2025/0328517 A1
(43) Pub. Date: Oct. 23, 2025

(54) SYSTEM AND METHOD FOR PAYLOAD DATA AND MOUNT INTEGRITY CHECK

(71) Applicant: Microavia International Limited, Dublin (IE)

(72) Inventors: Nikita Bondarev, Dubai (AE); Anton Babushkin, Zurich (CH); Yuriy Kamnev, Dubai (AE)

(21) Appl. No.: 18/640,487

(22) Filed: Apr. 19, 2024

(51) Int. Cl. G06F 16/23; G06F 16/215; G06F 16/27

(52) U.S. Cl. CPC G06F 16/2365; G06F 16/215; G06F 16/27

(57) ABSTRACT

Systems and methods for assessing the integrity of payload mounts and the correctness of data collected by payloads on unmanned vehicles, using a dispersion assessment approach. Systems and methods efficiently and accurately determine the stability of payload fastenings and the reliability of payload-derived data, applicable across various types of unmanned vehicles.

### TECHNICAL FIELD

The invention relates generally to unmanned vehicle technologies and payload data processing systems. More particularly, the invention relates to systems and methods for assessing the integrity of payload mounts and the correctness of data collected by payloads on unmanned vehicles, using a dispersion assessment approach.

### BACKGROUND

The present invention pertains to the field of unmanned vehicle technologies. In the field of unmanned vehicles, which encompasses a wide range of platforms including aerial, terrestrial, and aquatic systems, a pivotal concern is the assurance of integrity and proper functionality of payloads and their mounts. These payloads, varying from cameras and LIDAR systems to other specialized instruments, are fundamental to numerous applications such as surveying, reconnaissance, and environmental monitoring. However, challenges arise when payloads or associated mounts are subject to damage or are not installed correctly, leading to compromised system performance and data reliability.

The conventional approach to address the issue of payload mounting involves equipping the payload with additional sensors to determine its position and attitude. Such a system requires additional sensors, while effective in certain scenarios, has notable drawbacks. The integration of extra sensors directly onto the payload increases the overall cost and complexity of the system. More critically, the added weight and bulk of these sensors can adversely impact the operational capabilities of the unmanned vehicle, particularly in cases where payload size and weight are limiting factors.

Therefore, there is a need for an efficient, lightweight, and universally applicable solution capable of assessing the quality of payload mounting and the accuracy of the data collected across various types of unmanned vehicles.

### SUMMARY

The present disclosure relates to systems and methods for assessing the integrity of payload mounts and the correctness of data collected by payloads on unmanned vehicles

Embodiments described or otherwise contemplated herein substantially meet the aforementioned needs of the industry. Embodiments can verify whether a payload is correctly mounted and functioning without the necessity of additional payload-mounted sensors, thereby offering a cost-effective, less cumbersome alternative to traditional solutions.

A method for assessing integrity of target data of a payload mounted to the unmanned vehicle (UV) with a mount and integrity of the mount comprises collecting positioning data from sensors on the UV, synchronizing the collected positioning data with an onboard processor of the payload as synchronized data, uploading a dynamic model for a specific type of payload mounted to the UV, processing the synchronized sensor data and measurements received from a dedicated IMU of the payload and system parameters defined by the dynamic model using an Extended Kalman Filter (EKF) to calculate a covariance matrix of dispersions characterizing the level of uncertainty in a position estimate for the payload and an attitude estimate for the payload and analyzing the covariance matrix of dispersions to determine a state of a payload target data and the mount.

In one aspect, the collected positioning data includes data from a Global Navigation Satellite System (GNSS) receiver.

In one aspect, the collected positioning data includes data from an Inertial Measurement Unit (IMU).

In one aspect, the dynamic model is configured to mechanical constraints of the mount, including degrees of freedom and damping properties.

In one aspect synchronization of the collected positioning data includes aligning timestamps of the sensors on the UV with timestamps of the onboard processor of the payload.

In one aspect, the payload is at least one of a camera or LIDAR.

In one aspect, the method further comprises updating the covariance matrix of dispersions with new sensor data obtained during the operation of the UV.

In one aspect, analyzing the covariance matrix of dispersions is performed using a machine learning classification model, where in each class of classification is characterized by thresholds of particular dispersion values.

In one aspect, analyzing the covariance matrix of dispersions is performed in various operational states of the UV.

A system for providing integrity of an unmanned vehicle (UV) mounted to a payload with a mount comprises an unmanned vehicle (UV), a payload, communicatively coupled to the UV, a quality checker configured to analyze the covariance matrix of dispersions to determine a state of the payload data and the mount, a mount connecting the payload to the UV, configured to allow specific degrees of freedom and having damping properties, and the dynamic model uploaded to the system corresponding to the type of the payload, defining the system parameters. The UV comprises a sensor configured to collect positioning data. The payload comprises a processor configured to obtain positioning data from UV in synchronized manner, a dedicated Inertial Measurement Unit (IMU) configured to capture motion-related data and an Extended Kalman Filter (EKF) module configured to process the synchronized positioning data, motion-related data, and system parameters defined by a dynamic model to calculate a covariance matrix of dispersions characterizing a level of uncertainty in position and attitude estimates of the payload.

In one aspect, the system further comprises an autopilot of UV configured to process the collected sensor data and to determine the position of the UV, and wherein the processor is further configured to obtain the UV position as positioning data.

In one aspect, the quality checker further comprises a machine learning classifier configured to classify the state of the payload data and mount integrity by dispersion values.

In one aspect, the quality checker analyzes the covariance matrix in a plurality of operational states of the UV.

In one aspect, the sensor is at least one of Global Navigation Satellite System (GNSS) receiver, an Inertial Measurement Unit (IMU) or a compass.

A method for providing integrity of an unmanned vehicle (UV) including a payload mounted on the UV with a mount comprises collecting UV sensor data, synchronizing the sensor data with motion-related data from the payload using a timestamp as synchronized sensor data, processing the synchronized positioning data using an Extended Kalman Filter (EKF) to calculate a covariance matrix of dispersions characterizing a level of uncertainty in payload position and attitude estimates and analyzing the covariance matrix of dispersions to determine a state of payload data and the mount.

In one aspect, the method further comprises classifying the state of the payload data and the mount using a machine learning classifier.

In one aspect, processing the synchronized positioning data further comprises predicting behavior of the payload in relation to a mount and the UV.

In one aspect, predicting behavior of the payload includes analysis with a dynamic model, the dynamic model defining degrees of freedom of the mount, spatial offsets, and damping characteristics of the mount.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a schema of an equipped unmanned aerial vehicle, according to an embodiment.

FIG. 2 is a block diagram depicting the relative movement of an unmanned vehicle and a payload under different operational states, according to an embodiment.

FIG. 3 is a view on two surface maps captured using a LIDAR sensors with different levels of data quality.

FIG. 4 is a block diagram of an equipped unmanned vehicle, according to an embodiment.

FIG. 5 is a functional schema of payload data and mount integrity check, according to an embodiment.

FIG. 6 is a flowchart of a method for payload data and mount integrity check, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Unmanned vehicles (UVs) encompass a broad range of vehicles operated without direct human control. These vehicles can be classified based on their operational environment, such as aerial unmanned aerial vehicles (UAVs), terrestrial unmanned ground vehicles (UGVs), aquatic unmanned surface vehicles (USVs), and subaquatic unmanned underwater vehicles (UUVs). Each category of UVs can be further divided by its application, size, range, and the nature of its control systems, whether autonomous or remotely piloted.

Mounts for payloads on UVs are components that directly affect the stability and efficacy of the data collection process. Mounts are typically categorized by their stabilization capabilities and range of motion. Damped mounts utilize materials and mechanisms that absorb vibrations and shocks. Motorized mounts incorporate servo motors or stepper motors that offer precise control over the payload's orientation. Articulated mounts feature joints and linkages that provide multiple degrees of freedom, and telescopic mounts can extend or retract, changing the payload's relative position to the UV.

Payloads for UVs are diverse, including sensors and instruments designed for specific operational tasks. Cameras, as an example of a payload, capture visual data in the form of images or videos. A LIDAR payload generates surface maps by emitting laser pulses and measuring the reflected signals to calculate distances. Other payloads can include thermal cameras, multispectral sensors, scientific instruments, or even cargo for delivery purposes.

Target payload data refers to the specific data gathered by the payload's key sensor. For a camera, the target data can be high-resolution images or continuous video footage, which can be used in surveillance, inspection, or environmental monitoring. In the case of a LIDAR sensor, the target payload data can be detailed surface maps and 3D models of the environment, vital for applications such as topographic mapping, archaeology, and urban planning.

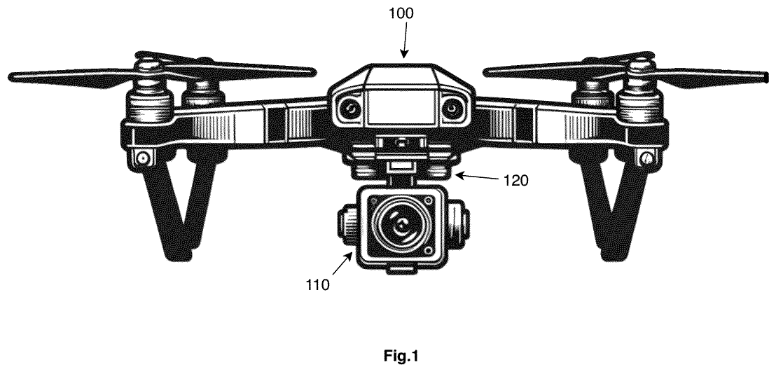

Referring to FIG. 1, schema of an equipped unmanned aerial vehicle is depicted, in an embodiment. In one embodiment, an unmanned aerial vehicle 100 is equipped with a payload, specifically a camera 110, which is installed on the unmanned aerial vehicle 100 using a damped mount 120. The unmanned aerial vehicle 100 includes a plurality of rotors and an onboard navigation system, not shown in FIG. 1, for stabilizing and navigating the unmanned aerial vehicle 100 through three-dimensional space.

The camera 110 is operably coupled to the unmanned aerial vehicle 100 and is configured to capture images and videos. In another embodiment, the camera 110 may include additional sensors not shown in FIG. 1, such as an Inertial Measurement Unit (IMU) for capturing motion data. The unmanned aerial vehicle 100, equipped with a damped mount 120, is configured to decrease the offset and relative motion of the payload, such as the camera 110 or a LIDAR system, from the standpoint of the unmanned aerial vehicle 100. Displacements and oscillations of the payload relative to the UV 100, referred to as residual movements, despite the damping provided by the damped mount 120, can arise due to various external and operational factors and significantly impact the reliability of the payload's data. These movements are not just a matter of stabilization or damping but are crucial indicators of the normal or abnormal functioning of the payload's fastening and mount.

For a payload like a LIDAR system, normal operational movements are expected due to the dynamics of the unmanned vehicle 100 and external environmental factors. However, any deviation beyond these expected movements might signal potential faults in the payload's fastening or damages to the mount. Accurately assessing these deviations is key to ensuring the reliability of the LIDAR data. If the residual movements fall outside the normal range, it could indicate issues with the mount integrity, leading to incorrect LIDAR readings and flawed environmental mapping.

Similarly, with a camera 110 as the payload, normal residual movements are anticipated due to the vehicle's maneuvers. However, abnormal movements, distinct from the usual operational range, can adversely affect the quality of the captured images. Such abnormal movements could result from a compromised mount or improper fastening of the camera. Detecting and analyzing these deviations are essential to ascertain the camera's stability and the fidelity of the photographic data.

In essence, the system presented in FIG. 1 is configured not merely to dampen movements but to critically assess whether the movements of the payload relative to the unmanned vehicle 100 fall within a normal operational range or indicate potential mechanical issues or faults. The assessment of movements is vital for confirming the integrity of the payload mount and the correctness of the data collected by the payload.

In one embodiment, the damped mount 120 not only mechanically connects the camera 110 to the unmanned aerial vehicle 100 but also facilitates the transfer of data and control signals. The damped mount 120 is equipped with the necessary interfaces to allow for the bi-directional transfer of data packets between the camera 110 and the unmanned aerial vehicle 100. The connectivity channel ensures that the camera 110 can receive control commands from the onboard systems of the unmanned aerial vehicle. The connectivity channel ensures that the camera 110 can transmit captured image and video data back to the unmanned aerial vehicle 100 for processing or relay to the ground control station 120.

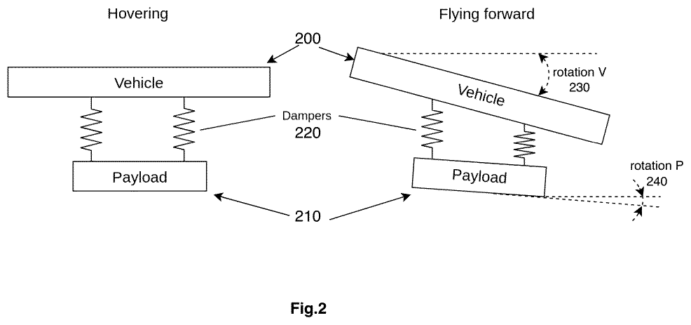

Referring to FIG. 2, a block diagram depicting the relative movement of an unmanned vehicle 200 and a payload 210 under different operational states is depicted, according to an embodiment. FIG. 2 illustrates two distinct states: “Hovering” and “Flying forward.”

In the “Hovering” state, the unmanned vehicle 200 is stationary in the air, and the payload 210 is depicted as being stationary relative to the unmanned vehicle 200. The payload 210 is connected to the unmanned vehicle 200 via dampers 220, which serve to cushion any vibrational forces that may act upon the payload 210.

As the unmanned vehicle 200 transitions to the “Flying forward” state, dynamics change considerably. The unmanned vehicle 200 tilts forward at a rotation angle V 230 as the unmanned vehicle moves with acceleration, which is a typical maneuver for maintaining forward momentum. Concurrently, the payload 210, while still connected to the unmanned vehicle 200 via dampers 220, oscillates in one plane relative to the unmanned vehicle 200, turning through a rotation angle P 240 relative to the horizon. FIG. 2 illustrates the payload's degree of freedom to move.

The angle of relative rotation between the unmanned vehicle 200 and the payload 210 in an ideal system is determined by the design of the mount, which includes considerations of materials used, tolerances of distances between structural parts, and the overall geometry of the design. Additionally, the mass and geometry of the payload 210 itself play significant roles in the vibration characteristics of the payload 210.

The dynamic model within the context of unmanned vehicle systems, such as the unmanned vehicle 200 illustrated in FIG. 2, is utilized for predicting and managing the behavior of a payload 210 in relation to its mount and the vehicle itself. The dynamic model captures the dynamic interaction between the unmanned vehicle 200 and the payload 210, considering the degrees of freedom facilitated by various types of mounts. The dynamic model defines mechanical constraints of the mount. In other embodiments, other relational characteristics are considered, such as coupling between the mount and vehicle.

For damped mounts, such as the dampers 220 shown in FIG. 2, the dynamic model focuses on the constrained roll and pitch movements permitted by the damping mechanism. The model includes parameters defining the mechanical properties of the dampers 220, which dictate how the payload 210 responds to inertial forces and movements of the unmanned vehicle 200.

In motorized mounts, the dynamic model encompasses a broader range of controlled movements. Motorized mounts enable precise adjustments across multiple axes, allowing dynamic repositioning of the payload 210. The model for such mounts details the actuator capabilities, control algorithms, and the response of the payload 210 to actuator-induced movements.

Articulated mounts introduce multi-axis movement capabilities, which necessitate a dynamic model that accounts for joint angles, linkage configurations, and the sequences of movements the payload 210 can undertake. These mounts are particularly useful for tasks that require the payload 210 to maneuver through complex spatial paths.

Telescopic mounts are modeled to highlight their capacity for altering the position of the payload 210 along a single axis, offering an additional degree of freedom for payloads that benefit from variable positioning. The dynamic model for telescopic mounts includes parameters such as extension range, retraction mechanics, and the speed of these movements.

For systems that combine different mount types, the dynamic model integrates the individual characteristics of each mount into a cohesive system. The integrated dynamic model can adapt to a wide array of operational requirements, providing both stability and precise positioning for the payload 210.

System parameterization further defines the spatial relationship between reference points of the unmanned vehicle 200 and the origin of the payload 210. The spatial relationship includes the dual offsets-one from the center of unmanned vehicle 200 to the mount point and another from the mount point to the center of payload 210. By employing the dual-offset approach, the dynamic model effectively separates parameters of the unmanned vehicle 200 from those of the payload 210, enhancing the system's adaptability.

Additionally, the dynamic model takes into account the characteristics of the dampers 220, where applicable. Damping characteristics encompasses the range of motion the dampers 220 allow and their damping coefficients, which influence the reaction of the payload 210 to the movements of the unmanned vehicle 200 and any external disturbances.

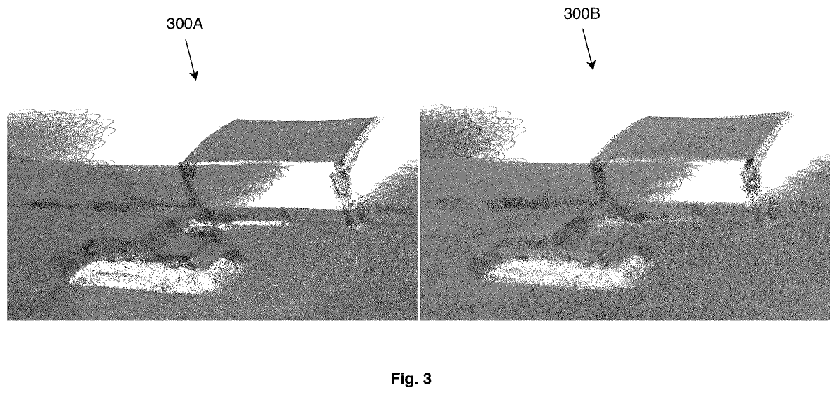

Referring to FIG. 3, a comparative representation of two surface maps denoted as 300A and 300B are depicted, according to an embodiment. These maps are the result of data obtained from LIDAR sensors mounted on Unmanned Vehicles (UVs) situated at a specific spatial location under typical operational conditions.

FIG. 3 illustrates a critical issue concerning data acquisition systems based on UVs. Notably, surface map 300A exhibits a higher level of detail compared to surface map 300B. A difference in detail highlights the dispersion present in the estimations of the position and attitude of LIDAR sensors.

The issue under consideration pertains to the accuracy and reliability of the data collected by these LIDAR sensors. In applications requiring precise cartography and surveying, ensuring the quality of the acquired data is of utmost importance. The dispersion observed in the estimations of position and attitude, as visually demonstrated in these surface maps, can significantly impact the quality and accuracy of the collected data.

Furthermore, these residual movements, as exemplified by the dispersion portrayed in the maps, may vary depending on various conditions, the dynamics of the UVs, and operational factors. Determining whether these deviations conform to acceptable thresholds or indicate issues with mounting mechanisms or damage to the payload mounts is a primary concern addressed by the systems and methods disclosed herein.

FIG. 3 serves as a visual representation that encapsulates the essence of the problem solved herein. It underscores the need for effective solutions that scrutinize data accuracy and the quality of payload mounting within data acquisition systems centered around UVs. The system and methods described herein mitigate these challenges and enhance the reliability of data obtained from payloads affixed to UVs.

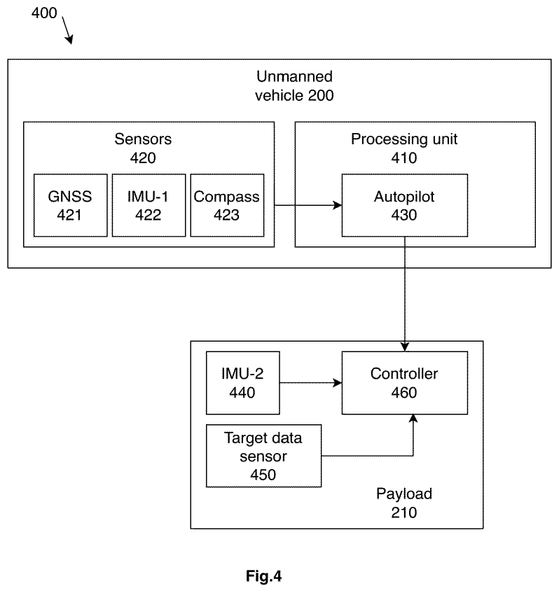

Referring to FIG. 4, a block diagram 400 illustrating the sensor and control system architecture of an unmanned vehicle 200 is depicted, according to an embodiment. In an embodiment, the sensor and control system architecture is configured to assess the dispersion of payload position estimation and subsequently evaluate the quality of payload mounting and data integrity.

The unmanned vehicle 200 is equipped with an array of sensors 420 integral to its navigation and positioning capabilities. These sensors include a Global Navigation Satellite System (GNSS) receiver 421, an Inertial Measurement Unit (IMU-1) 422, and a compass 423, among potentially other positioning sensors not explicitly shown in the diagram. The sensors 420 provide real-time data on spatial orientation, velocity, and geographic location of the unmanned vehicle 200.

A processing unit 410 within the unmanned vehicle 200 interprets the data from the sensors 420 to maintain and adjust the flight dynamics of the unmanned vehicle 200. In an embodiment, the processing unit 410 can be operably coupled to memory. The autopilot 430 utilizes the data from sensors to ascertain the position and attitude of the unmanned vehicle 200 and to generate control signals that guide the unmanned vehicle 200 in accordance with its mission parameters and to compensate for external factors, such as weather conditions.

The payload 210, which can be a camera system, LIDAR sensor, or another instrument dependent on precise positioning, includes its dedicated Inertial Measurement Unit (IMU-2) 440 and a controller 460. The IMU-2 440 captures motion-related data specific to the payload 210, such as vibrations or independent movements, which are not directly related to the maneuvers of the unmanned vehicle 200. In an embodiment, the controller 460 can be operably coupled to memory.

In one embodiment, the dispersion of the payload's position estimation is assessed. The payload's controller 460, which receives the calculated position of the unmanned vehicle 200 from the autopilot 430, places a heightened emphasis on analyzing dispersions in the estimated payload position and attitude. By examining the covariance matrix as a measure of dispersion, the system determines the level of uncertainty in the payload's position and attitude estimates. Higher dispersion values may indicate potential issues with the payload's mounting or data quality.

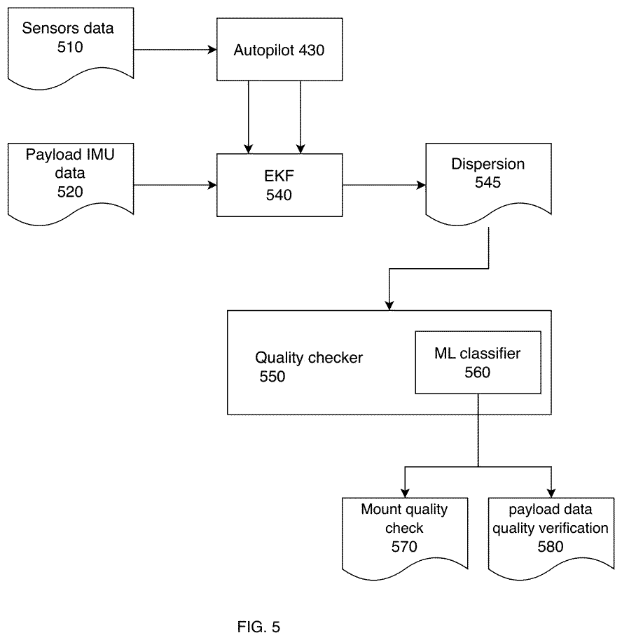

Referring to FIG. 5, a functional schema of the payload dispersion assessment and quality evaluation system for an unmanned vehicle 200 is depicted, according to an embodiment. FIG. 5 depicts a data flow that begins with sensor data 510 from an unmanned vehicle's array of navigational instruments, which is then processed by the autopilot 430.

The autopilot 430, along with the payload's onboard processor, is time-synchronized to ensure that the collected data is accurately timestamped, facilitating precise data matching and integration. Time synchronization, essential for ensuring that the data streams from the vehicle and the payload are precisely aligned in time, is utilized for the accurate fusion and processing of data by the EKF. Such timestamp alignment ensures that the positional and attitudinal estimations made by the EKF are based on data that is temporally coherent, eliminating discrepancies that could arise from data misalignment. The accurate synchronization of these data streams is vital for the precision of the EKF's output, which directly influences the quality of the corrected target data, leading to more reliable and accurate results in applications such as terrain mapping or object detection. While a single frequency is described herein, varying frequencies can be utilized for a single implementation. For example, time synchronization can be implemented at a first frequency during startup, and at a second frequency during continued operation.

Payload IMU data 520, sourced from the payload's own Inertial Measurement Unit (IMU), is also fed into the EKF 540.

In different embodiments of the system depicted in FIG. 5, components such as the EKF 540 and the autopilot 430 can be either hardware-based or software-based, offering flexibility depending on the application. In an embodiment, certain components of the system can be implemented on hardware remote from the UV. The UV can be operably coupled to such remote components through a network or other communication interface. However, such an approach can increase the system's overall cost and complexity. On the other hand, a software-based implementation, running on a computing platform within the unmanned vehicle or payload, provides versatility and ease of updates or customization. A flexibility of software-based implementation is advantageous for applications such as environmental monitoring or agricultural mapping, where adaptability to varying conditions is key.

Moreover, in embodiments, certain functionalities can be transferred between system components. For example, it may be advantageous for UV components to implement certain functionality when the output is time-critical or when the UV is unable to communicate with remote components. In another example, it may be advantageous for remote components to implement certain functionality when UV battery life is critical.

Following data acquisition, the initial processing stage involves processing the data through the Extended Kalman Filter (EKF) 540. EKF 540 is generally configured for estimating the payload's position and attitude and extracting the covariance matrix as a measure of dispersion or uncertainty in the estimates. Using the output of the EKF 540, embodiments can assess the dispersion in the payload's position estimation to evaluate the quality of payload mounting and data integrity.

The EKF operates in a series of computational operations to refine the state estimates of the payload's position and attitude through a combination of prediction and measurement updates.

The algorithm begins with Initialization, where the state vector (x) is established. The state vector encapsulates the initial estimates of the payload's position and attitude. Accompanying the state vector is the covariance matrix (P), which quantifies the initial uncertainty associated with these state estimates.

The Predict Step involves making predictions about the payload's position and attitude based on sensor data and control inputs, while the Update Step refines these estimates with each new cycle of data, reducing uncertainty through sequential updating. The dispersion, or measure of uncertainty, decreases with each iteration of the EKF 540, reflecting increased confidence in the payload position estimates.

Proceeding to the Predict Step, the state prediction formula x{pred}=f (x{prev}, u) is applied, where f( ) represents the state transition function, x{prev} is the state vector from the previous step, and u denotes the control input derived from the unmanned vehicle's sensors. The covariance matrix is also predicted, using the formula P{pred}=F*P{prev} *F\hat{ }T+Q, where F is the Jacobian matrix of the state transition function, P{prev} is the covariance matrix from the previous step, and Q symbolizes the process noise covariance.

In the subsequent Update Step, the measurement update occurs, utilizing the formula y=z−h (x{pred}), with z representing the actual measurements, h being the measurement function, and x{pred} the predicted state vector. The Jacobian of the measurement function (H) is calculated to inform the computation of the Kalman Gain (K) using the formula K=P{pred} H\hat{ }T (HP{pred} H\hat{ }T+R)\hat{ }{−1}, where R is the measurement noise covariance. The state vector is then updated to x{updated}=x{pred}+Ky, and the covariance matrix is revised to P{updated}=(I−KH)*P{pred}. The estimation process is repeated with each new iteration, using the updated state and covariance estimates as the starting point for the next cycle, ensuring that the payload's position and attitude are continually refined.

The EKF is instrumental in enhancing the precision of the payload's position and attitude estimates, which are integral components of the state vector x. Through the prediction and update cycles, the EKF systematically reduces the uncertainty in these estimates, as indicated by the decreasing values within the covariance matrix P. The dispersion, or the measure of uncertainty, diminishes with each iteration, signaling an increase in the confidence level of the state estimates, which is utilized for the accuracy of the payload's operational data.

The dispersion output 545 from the EKF 540 serves as input for the quality checker 550, which assesses mount quality and payload data integrity. A dispersion analysis phase follows, where the covariance matrix is analyzed to assess the level of uncertainty in the payload's position and attitude estimates. Higher dispersion indicates greater uncertainty, which can be due to incorrect data, sensor errors, or instability in the payload mount. In another embodiment, quality checker 550 processes dispersion and estimated position and/or attitude of the payload as input data to assess the quality of the mounting and target data.

To add depth and precision to the payload's data and mount integrity assessment, a machine learning classifier 560 within the quality checker 550 analyzes the covariance matrix of dispersions. Such approach examines relationships between different dispersion values, allowing for a more sophisticated and accurate analysis of the payload's state.

In an embodiment, machine learning classifier 560 can be trained to classify dispersions. Machine learning refers generally to training computers to make decisions from data without being explicitly programmed. It involves training algorithms on data sets to recognize patterns, make predictions, or perform tasks, becoming more accurate as they process more data. In an embodiment, machine learning can be implemented using supervised learning, unsupervised learning, semisupervised learning and reinforcement learning. Learning algorithms such as convolutional neural networks and recurrent neural networks are used in supervised, unsupervised and reinforcement learning tasks, based on the specific problem and availability of data.

In one embodiment, the ML classifier 560 assesses each dispersion value and compares the dispersion value to thresholds that are determined on a ML training stage or predefined in a dynamic model. In another embodiment, ML classifier 560 assesses relationships between different dispersion values, allowing ML classifier 560 to distinguish normal operation from potential issues based on dispersion data.

In one aspect, the quality checker 550 examines pairs of dispersion values. For example, if dispersions “A” and “B” together exceed certain thresholds, it is considered normal. However, if only dispersion “A” or “B” crosses the threshold, it may indicate a problem. In embodiments, if “A” and “B” in an aggregation or summing crosses a given threshold, a problem may be indicated. In another embodiment, three or more dispersion values are considered. For example, “A,” “B,” and “C” values can each be considered separately. In another example, “A,” “B,” and “C” values can be aggregated or summed for comparison against a single threshold.

The system dynamically sets thresholds based on the ML classifier 560 model learning from operational scenarios. The dynamic thresholding reduces false positives or negatives, particularly during initial EKF operation with naturally higher dispersions. For example, in a first operational scenario in which the UV is allowed greater tolerances for quality (e.g. on initial launch or landing), the dynamic threshold is increased to prevent false positives. In another example in which the UV is allowed relatively tighter tolerances for quality (e.g. during steady flight or when a payload is active), the dynamic threshold is decreased to prevent false negatives.

Persistent high dispersion across different operational conditions suggests potential mount or fastening problems, leading to further investigation. For payload data quality assessment, high dispersion indicates potential data inaccuracies, necessitating recalibration or re-examination.

Based on dispersion analysis and quality assessment, the system (via quality checker 550) provides feedback to the unmanned vehicle's control system or payload protocol, triggering necessary adjustments to enhance system performance and data quality. In summary, the ML classifier 560 in the quality checker 550 evaluates data correctness 580 and mount integrity 570 by analyzing dispersions, adapting thresholds dynamically, and providing actionable feedback for unmanned vehicle optimization.

In an embodiment, mount integrity 570 comprises a measure of the condition of the mount relative to the payload. The measure of the condition can represent a value from 0 to 1, a percentage of integrity, or several levels of condition (good, bad or normal).

In an embodiment, data correctness 580 comprises a measure of the accuracy of the data from the payload. The measure of the condition can represent a value from 0 to 1, a percentage of data correctness in comparison with data collected from a stable payload, or several levels of accuracy (for example, good, bad or normal).

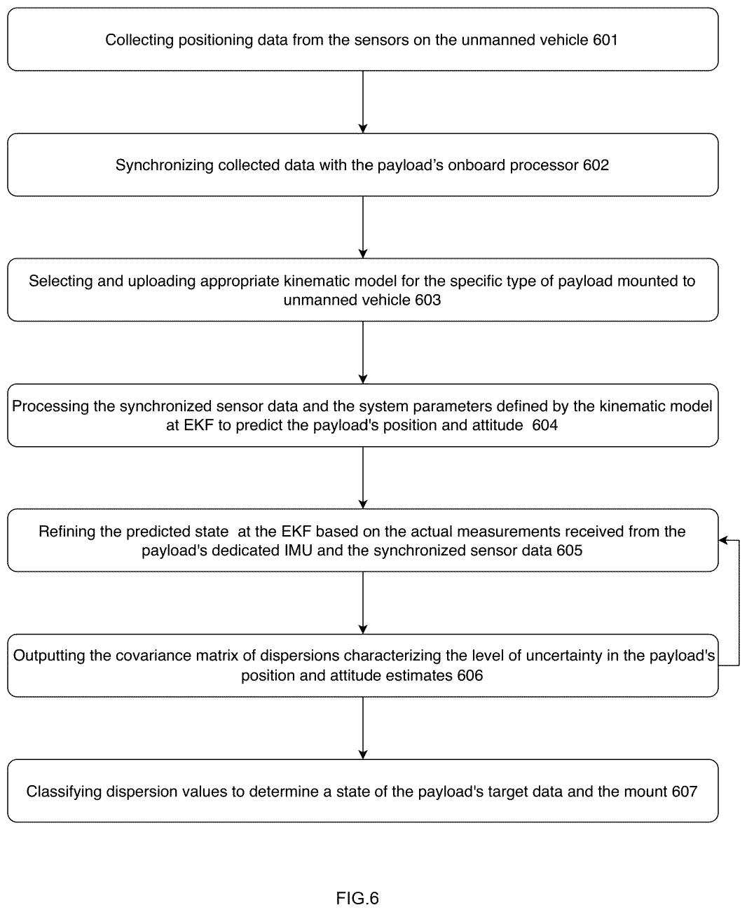

Referring to FIG. 6, a method for checking correctness of target data from a payload on an unmanned vehicle and evaluating the integrity of the payload's mount or fastening mechanism is depicted, according to an embodiment. The method includes operations to ensure the reliability and quality of the payload's data, particularly for sensitive payloads like LIDAR systems or high-resolution cameras.

In an embodiment, operation 601 includes the active collection and computation of positioning data from the sensors installed on the unmanned vehicle. Sensors can include a Global Navigation Satellite System (GNSS) receiver, an Inertial Measurement Unit (IMU), a compass, and other navigation sensors. The data collected from such sensors collectively form the basis for all subsequent position and attitude estimations. In an embodiment, active collection can include continuous or periodic collection from sensors.

Moving to operation 602, the collected data is meticulously synchronized with the payload's onboard processor. The synchronization process ensures that the data, which is timestamped, aligns accurately between the unmanned vehicle and the payload. Data alignment is required for the precise fusion and processing of the data.

Continuing with operation 603, an appropriate dynamic model is selected and loaded based on the specific type of payload and mount employed. In an embodiment, the dynamic model can be associated with both the payload and mount. In other embodiments, the dynamic model can be associated with other suitable characteristics that reflect the hardware implemented by the UV and mount (such as fasteners, etc.) The dynamic model takes into account the physical and operational characteristics of the mount mechanism, including damping properties and degrees of freedom. Additionally, the dynamic modelfine-tunes the parameters of the Extended Kalman Filter (EKF) system used in subsequent calculations. In an embodiment, the dynamic model can be automatically selected. In other embodiments, the dynamic model can be conditionally automatically selected but approved by a user.

In an embodiment, a dynamic model defines the following parameters: a) degrees of freedom of the mount; b) Spatial Offsets (including offsets in three-dimensional space (x, y, z) and might also account for angular offsets); c) Damping Characteristics. Optionally, the dynamic model can define other parameters, that can be used for advanced mount types of high-precise data gathering: d) motion dynamics (velocities and accelerations of payload and vehicle in different axes are used for understanding how the vehicle's movements impact the payload); e) control inputs from the vehicle's autopilot (like thrust, tilt angles, etc.), which directly influences the vehicle's motion and, indirectly, the payload's position; f) payload characteristics (mass, dimensions, tensors of inertia and center of gravity).

At operation 604 the EKF employs the synchronized sensor data and the system parameters defined by the dynamic model to process and predict the payload's position and attitude that encompasses a state prediction and a covariance prediction, both of which factor in the presence of process noise. In an embodiment, a state transition function of the EKF, employed in the prediction operation at 604, is informed by the dynamic model. In an embodiment, a state transition function leverages the model to make predictions regarding the payload's future state, considering its current state and control inputs. Furthermore, in another embodiment, the measurement function within the EKF, responsible for mapping the predicted state to expected measurements, is also based on the dynamic model. The measurement function correlates the payload's predicted position and orientation with the actual sensor readings.

At operation 605, the EKF executes an update procedure using the actual measurements received from the payload's dedicated IMU. The update operation 605 refines the predicted state, making necessary adjustments to the state vector and the covariance matrix. These adjustments serve to reduce the level of uncertainty in the estimates. In embodiments, the predicted state can be updated continuously or intermittently.

In operation 606, the EKF produces dispersion values as a result of the covariance calculations. These dispersion values represent the uncertainty in the payload's estimated position and attitude. Subsequent operation 607 includes the classification of these dispersion values to determine a state of the payload's target data and the mount. In an embodiment, the classes of states comprise: a) normal, and b) abnormal. In embodiments, additional classes characterizing different states can also be defined, such as: a) the mount is damaged, b) payload data is not reliable due to hard vibration of the payload. The classification process considers individual dispersion values, series of dispersion values, and subsets of dispersion values. By focusing on relationships between different dispersion values and adapting thresholds dynamically, anomalies indicative of potential issues with the payload or its mount are identified.

In operation 608, the system generates notifications based on the results of the dispersion analysis and classification. These notifications may relate to data and mount integrity, indicating the correctness and reliability of the payload's data, or they may signal issues with the mount or payload, such as errors, damage, or the need for recalibration and maintenance work. In embodiments, notifications can be relayed to a user of the UV or system or subsystem of the UV, including on the UV itself. A comprehensive method ensures the accurate determination of the payload's position and attitude, followed by the detection of anomalies in dispersion values and appropriate notifications regarding data and mount integrity or potential issues.

1. A method for assessing integrity of target data of a payload and integrity of a mount, the payload mounted to the to the unmanned vehicle with the mount, the method comprising:
collecting positioning data from sensors on the unmanned vehicle;
synchronizing the collected positioning data with an onboard processor of the payload as synchronized data;
uploading a dynamic model for a specific type of payload mounted to the unmanned vehicle;
processing the synchronized sensor data and measurements received from a dedicated inertial measurement unit of the payload and system parameters defined by the dynamic model using an extended Kalman filter to calculate a covariance matrix of dispersions characterizing the level of uncertainty in a position estimate for the payload and an attitude estimate for the payload; and
analyzing the covariance matrix of dispersions to determine a state of a payload target data and the mount.

2. The method of claim 1, wherein the collected positioning data includes data from a global navigation satellite system receiver.

3. The method of claim 1, wherein the collected positioning data includes data from an inertial measurement unit.

4. The method of claim 1, wherein the dynamic model is configured to mechanical constraints of the mount, including degrees of freedom and damping properties.

5. The method of claim 1, wherein the synchronizing the collected positioning data includes aligning timestamps of the sensors on the unmanned vehicle with timestamps of the onboard processor of the payload.

6. The method of claim 1, wherein the payload is at least one of a camera or LIDAR.

7. The method of claim 1, further comprising updating the covariance matrix of dispersions with new sensor data obtained during the operation of the unmanned vehicle.

8. The method of claim 1, wherein analyzing the covariance matrix of dispersions is performed using a machine learning classification model, where in each class of classification is characterized by thresholds of particular dispersion values.

9. The method of claim 1, wherein analyzing the covariance matrix of dispersions is performed in various operational states of the unmanned vehicle.

10. A system for providing integrity of an unmanned vehicle mounted to a payload with a mount, the system comprising:
an unmanned vehicle, comprising:
a sensor configured to collect positioning data;
a payload, communicatively coupled to the unmanned vehicle, comprising:
a processor configured to obtain positioning data from the unmanned vehicle in synchronized manner;
a dedicated inertial measurement unit configured to capture motion-related data; and
an extended Kalman filter module configured to process the synchronized positioning data, motion-related data, and system parameters defined by a dynamic model to calculate a covariance matrix of dispersions characterizing a level of uncertainty in position and attitude estimates of the payload;
a quality checker configured to analyze the covariance matrix of dispersions to determine a state of the payload data and the mount;
a mount connecting the payload to the unmanned vehicle, configured to allow specific degrees of freedom and having damping properties; and
the dynamic model uploaded to the system corresponding to the type of the payload, defining the system parameters.

11. The system of claim 10, further comprising an autopilot of the unmanned vehicle configured to process the collected sensor data and to determine the position of the unmanned vehicle, and wherein the processor is further configured to obtain the unmanned vehicle position as positioning data.

12. The system of claim 10, wherein the quality checker further comprises a machine learning classifier configured to classify the state of the payload data and mount integrity by dispersion values.

13. The system of claim 10, wherein the quality checker analyzes the covariance matrix in a plurality of operational states of the unmanned vehicle.

14. The system of claim 10, wherein the sensor is at least one of global navigation satellite system receiver, an inertial measurement unit or a compass.

15. The system of claim 10, wherein the dynamic model is configured to specific mechanical constraints of the mount, including degrees of freedom and damping properties.

16. The system of claim 10, wherein the payload is at least one of a camera or LIDAR.

17. A method for providing integrity of an unmanned vehicle including a payload mounted on the unmanned vehicle with a mount, the method comprising:
collecting unmanned vehicle sensor data;
synchronizing the sensor data with motion-related data from the payload using a timestamp as synchronized sensor data;
processing the synchronized positioning data using an extended Kalman filter to calculate a covariance matrix of dispersions characterizing a level of uncertainty in payload position and attitude estimates;
analyzing the covariance matrix of dispersions to determine a state of payload data and the mount.

18. The method of claim 17, further comprising classifying the state of the payload data and the mount using a machine learning classifier.

19. The method of claim 17, wherein processing the synchronized positioning data further comprises predicting behavior of the payload in relation to a mount and the unmanned vehicle.

20. The method of claim 19, wherein predicting behavior of the payload includes analysis with a dynamic model, the dynamic model defining degrees of freedom of the mount, spatial offsets, and damping characteristics of the mount.
